(19) United States
(12) Patent Application Publication
(10) Pub. No.: US 2026/0352042 A1
(43) Pub. Date: Nov. 5, 2026

(54) STATOR FOR ELECTRIC PROPULSION MACHINE, ELECTRIC PROPULSION MACHINE, AND VEHICLE

(71) Applicant: Scania CV AB, Södertälje (SE)

(72) Inventor: Christian Ness, Nykvarn (SE)

(21) Appl. No.: 19/487,130

(22) PCT Filed: May 24, 2024
(86) PCT No.: PCT/SE2024/050509

§ 371 Date: Nov. 24, 2025

(30) Foreign Application Priority Data
May 30, 2023 (SE) 2350658-7

(51) Int. Cl. H02K 1/20; B60K 1/00; H02K 9/19

(52) U.S. Cl. CPC H02K 1/20; B60K 1/00; H02K 9/19; B60K 2001/006

(57) ABSTRACT

A stator for an electric propulsion machine is disclosed, wherein the stator is configured to induce a torque to a rotor of the electric propulsion machine to rotate the rotor around a rotation axis. The stator comprises a first stator core portion a second stator core portion and a cooling unit positioned between the first and second stator core portions as seen along the rotation axis. The cooling unit forms a coolant path extending along more than 40% of a circumference of the stator. The present disclosure further relates to an electric propulsion machine and a vehicle comprising an electric propulsion machine.

### TECHNICAL FIELD

The present disclosure relates to a stator for an electric propulsion machine, wherein the stator is configured to induce a torque to a rotor of the electric propulsion machine to rotate the rotor around a rotation axis. The present disclosure further relates to an electric propulsion machine and a vehicle comprising an electric propulsion machine.

### BACKGROUND

The use of electric drive for vehicles provides many advantages, especially regarding local emissions. Such vehicles comprise one or more electric machines configured to provide motive power to the vehicle. These types of vehicles can be divided into the categories pure electric vehicles and hybrid electric vehicles. Pure electric vehicles, sometimes referred to as battery electric vehicles, only-electric vehicles, and all-electric vehicles, comprise a pure electric powertrain and comprise no internal combustion engine and therefore produce no emissions in the place where they are used.

A hybrid electric vehicle comprises two or more distinct types of power, such as an internal combustion engine and an electric propulsion system. The combination of an internal combustion engine and an electric propulsion system provides advantages with regard to energy efficiency, partly because of the poor energy efficiency of an internal combustion engine at lower power output levels. Moreover, some hybrid electric vehicles are capable of operating in pure electric drive when wanted, such as when driving in certain areas.

An electric machine is a machine that converts electrical energy into mechanical energy and vice versa. Most electric machines comprise magnets and wire windings, wherein the electric machine operate through the interaction between the magnetic field of the magnets and electric current in the wire windings to generate power in the form of rotation of a rotor of the electric machine. Also, some electric motors comprise wire windings as an alternative to magnets or in addition to magnets. The rotor is usually surrounded by a stator. Some electric machines comprise magnets in the rotor and wire windings in the stator and some other electric machines comprise wire windings in the rotor and magnets in the stator. However, for vehicle applications, electric machines most commonly comprise wire windings in the stator and magnets and/or wire windings in the rotor.

During operation of an electric machine, heat is generated in components thereof, especially in wire windings and the like components of the electric machine for example because of resistive losses therein. In general, it is desired to maintain the temperature of an electric machine below a predetermined threshold temperature in order to prevent deterioration and damage of the electric machine through thermal breakdown of insulation or thermal distortion due to thermal expansion of components of the electric machine. Moreover, overheating of an electric machine can lead to the issues, such as reduced efficiency, decreased lifespan, performance degradation, and safety hazards.

Therefore, many electric vehicles comprise a cooling system comprising a liquid coolant, such as oil or an aqueous/glycol mixture, for cooling the electric motor. However, due to the compact shape of an electric machine, and the many electrical components involved, it is difficult to design such a cooling system to obtain an efficient transfer of heat from hot portions of the electric machine to the coolant of the cooling system.

For these reasons, the power and torque output of an electric machine is normally restricted so as to no not exceed a predetermined threshold temperature of components of the electric machine.

Moreover, generally, it is an advantage if products, such as electric machines and associated components, systems, and arrangements, have conditions and/or characteristics suitable for being manufactured and assembled in a cost-efficient manner.

### SUMMARY

It is an object of the present invention to overcome, or at least alleviate, at least some of the above-mentioned problems and drawbacks.

According to a first aspect of the invention, the object is achieved by a stator for an electric propulsion machine, wherein the stator is configured to induce a torque to a rotor of the electric propulsion machine to rotate the rotor around a rotation axis. The stator comprises a first stator core portion, a second stator core portion, and a cooling unit positioned between the first and second stator core portions as seen along the rotation axis. The cooling unit forms a coolant path extending along more than 40% of a circumference of the stator.

Since the cooling unit is positioned between the first and second stator core portions as seen along the rotation axis and forms a coolant path extending along more than 40% of a circumference of the stator, an increased cooling capacity can be obtained of hot portions of the electric machine.

That is, as realized by the inventor of the solution according to the present disclosure, hot portions of an electric machine, i.e., portions normally developing high temperatures during high load situations of an electric machine, is radially inner parts of the stator at an axial centre of the stator. The term hot portions, as used herein, may also be referred to as hotspots.

Accordingly, by the positioning of the cooling unit between the first and second stator core portions, and the fact that the cooling unit forms a coolant path extending along more than 40% of a circumference of the stator, it can be ensured that coolant can reach locations close to hot portions of the electric machine to thereby cool the hot portions in a more efficient manner.

Thereby, problems related to overheating, such as reduced efficiency, decreased lifespan, performance degradation, and safety hazards, can at least be alleviated. In addition, conditions are provided for operating the electric machine at higher continuous power and torque levels without overheating the electric machine.

Accordingly, an electric machine is provided overcoming, or at least alleviating, at least some of the above-mentioned problems and drawbacks. As a result, the above-mentioned object is achieved.

Optionally, the coolant path encloses the rotation axis. Thereby, an increased cooling capacity can be further ensured of hot portions of the electric machine.

Optionally, the cooling unit is clamped between the first and second stator core portions. Thereby, an electric machine is provided in which the cooling unit forms a structural component of the electric machine while an efficient cooling of hot portions of the electric machine can be ensured. Moreover, an electric machine is provided having conditions and characteristics suitable for being manufactured and assembled in a cost-efficient manner.

Optionally, the first and second stator core portions have at least substantially the same length as measured along the rotation axis. In this manner, it can be further ensured that hot portions at an axial centre of the stator can be cooled in an efficient manner.

Optionally, each of the first and second stator core portions and the cooling unit comprises a number of stator slots, and wherein the stator comprises a number of wire windings arranged in the stator slots, and wherein the coolant path comprises a number of sections located between stator slots of the cooling unit. As mentioned, wire windings are components of an electric machine that generate a lot of heat during operation. Accordingly, since the coolant path comprises a number of sections located between stator slots of the cooling unit, it can be further ensured that coolant can reach locations close to hot portions of the electric machine to thereby cool the hot portions in a more efficient manner.

Optionally, the stator comprises a stator housing accommodating at least part of the first and second stator core portions, and wherein the stator housing comprises a coolant inlet and a coolant outlet each fluidly connected to the coolant path. Thereby, an efficient cooling of the electric machine can be further ensured.

Optionally, the coolant inlet and the coolant outlet are arranged on opposite sides of the rotation axis. Thereby, an efficient cooling of the electric machine can be ensured while providing conditions for avoiding the presence of air in the coolant path.

Optionally, the stator comprises a radial gap between the stator housing and each of the first and second stator core portions, wherein the radial gap forms a coolant volume enclosing at least part of each of the first and second stator core portions, and wherein the coolant path is fluidly connected to the coolant inlet and the coolant outlet respectively via the coolant volume. Thereby, an efficient cooling of the electric machine can be ensured in a simple and efficient manner.

Optionally, the cooling unit comprises a number of open faces together facing the coolant volume along more than 40% of the circumference of the cooling unit. Thereby, an efficient cooling of the electric machine can be further ensured, and an at least substantially unrestricted transfer of coolant can be provided between the coolant volume and the coolant path.

According to a second aspect of the invention, the object is achieved by an electric propulsion machine comprising a rotor and a stator according to some embodiments of the present disclosure, wherein the stator is configured to induce a torque to the rotor to rotate the rotor around a rotation axis. Since the electric propulsion machine comprises a stator according to some embodiments of the present disclosure, an electric propulsion machine is provided overcoming, or at least alleviating, at least some of the above-mentioned problems and drawbacks. As a result, the above-mentioned object is achieved.

According to a third aspect of the invention, the object is achieved by a vehicle comprising an electric propulsion machine according to some embodiments of the present disclosure, wherein the electric propulsion machine is configured to provide motive power to the vehicle. Since the vehicle comprising an electric propulsion machine according to some embodiments of the present disclosure, an electric propulsion machine is provided overcoming, or at least alleviating, at least some of the above-mentioned problems and drawbacks. As a result, the above-mentioned object is achieved.

Optionally, the vehicle is a heavy road vehicle, such as a truck or a bus. Thereby, a heavy road vehicle is provided having at least some of the above-mentioned advantages.

Further features of, and advantages with, the present invention will become apparent when studying the appended claims and the following detailed description.

### BRIEF DESCRIPTION OF THE DRAWINGS

Various aspects of the invention, including its particular features and advantages, will be readily understood from the example embodiments discussed in the following detailed description and the accompanying drawings, in which:

FIG. 1 illustrates a vehicle according to some embodiments,

FIG. 2 schematically illustrates an electric machine of the vehicle illustrated in FIG. 1,

FIG. 3 illustrates a perspective view of a stator of the electric machine illustrated in FIG. 2,

FIG. 4 illustrates a sectional view of a stator housing and a stator of an electric machine according to the embodiments illustrated in FIG. 2 and FIG. 3,

FIG. 5 illustrates a perspective view of a cooling unit of an electric machine explained with reference to FIG. 1-FIG. 4,

FIG. 6 illustrates an enlarged portion of the cooling unit illustrated in FIG. 5, and

FIG. 7 illustrates a cross section of a portion of a stator explained with reference to FIG. 1 FIG. 6.

### DETAILED DESCRIPTION

Aspects of the present invention will now be described more fully. Like reference signs refer to like elements throughout. Well-known functions or constructions will not necessarily be described in detail for brevity and/or clarity.

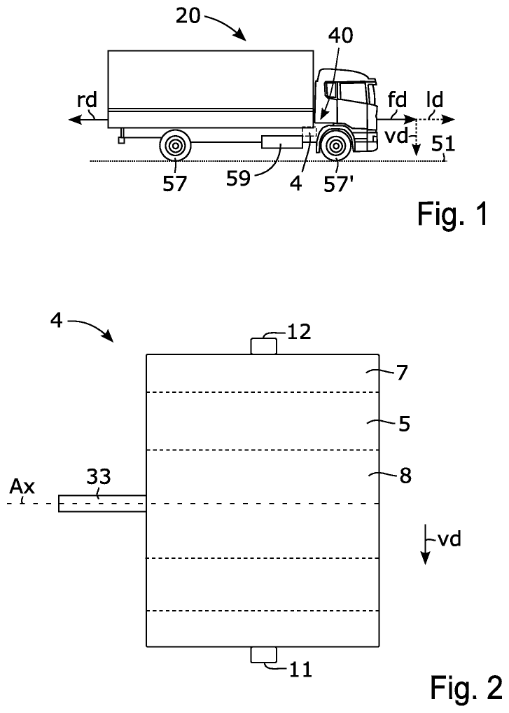

FIG. 1 illustrates a vehicle 20 according to some embodiments. According to the illustrated embodiments, the vehicle 20 is a truck, i.e. a type of heavy vehicle, as well as a type of heavy commercial vehicle 20. According to further embodiments, the vehicle 20, as referred to herein, may be another type of heavy or lighter type of manned or unmanned vehicle for land or water based propulsion such as a lorry, a bus, a construction vehicle, a tractor, a car, a ship, a boat, or the like.

The vehicle 20 comprises an electric powertrain 40. According to the illustrated embodiments, the electric powertrain 40 is configured to provide motive power to the vehicle 20 via wheels 57 of the vehicle 20. The electric powertrain 40 comprises an electric propulsion machine 4. For reasons of brevity and clarity, the electric propulsion machine 4 is in some places herein referred to as “an electric machine 4”. The electric machine 4 is capable of providing motive power to the vehicle 20 via wheels 57 of the vehicle 20 as well as providing regenerative braking of the vehicle 20. In other words, according to the illustrated embodiments, the electric machine 4 is capable of operating as an electric motor as well as an electric generator. The electric machine 4 of the vehicle 20 may also be referred to as a vehicle propulsion motor/generator 4.

According to the illustrated embodiments, the electric powertrain 40 of the vehicle 20 is a pure electric powertrain 40, i.e. a powertrain comprising no internal combustion engine. According to further embodiments, the electric powertrain 40 of the vehicle 20 may be a so called hybrid electric powertrain 40 comprising a combustion engine in addition to the electric machine 4 for providing motive power to the vehicle 20.

Moreover, in FIG. 1, a propulsion battery 59 of the vehicle 20 is indicated. The propulsion battery 59 is operably connected to the electric machine 4 and is configured to provide electricity thereto, and/or receive electricity therefrom, during operation of the electric powertrain 40. The propulsion battery 59 may comprise a number of battery cells, such as lithium-ion battery cells, lithium polymer batteries cells, or nickel-metal hydride battery cells.

In FIG. 1, the vehicle 20 is illustrated as positioned in an intended use position on a flat surface 51 supporting the vehicle 20. As seen in FIG. 1, wheels 57, 57′ of the vehicle 20 abut against the flat surface 51 when the vehicle 20 is positioned in the intended use position thereon. Moreover, in FIG. 1, a forward moving direction fd and a reverse moving direction rd of the vehicle 20 are indicated. The reverse moving direction rd of the vehicle 20 is opposite to the forward moving direction fd of the vehicle 20.

Moreover, in FIG. 1, a longitudinal direction Id of the vehicle 20 is indicated. The longitudinal direction Id of the vehicle 20 is parallel to a flat surface 51 supporting the vehicle 20 when the vehicle 20 is positioned in the intended upright use position thereon. Moreover, the longitudinal direction Id of the vehicle 20 is parallel to the forward moving direction fd of the vehicle 20 as well as to the reverse moving direction rd of the vehicle 20. Furthermore, in FIG. 1, a vertical direction vd of the vehicle 20 is indicated. The vertical direction vd of the vehicle 20 is perpendicular to the longitudinal direction Id of the vehicle 20. Moreover, when the vehicle 20 is positioned in the intended use position on a flat horizontal surface, the vertical direction vd of the vehicle 20 coincides with a gravity vector at the location of the vehicle 20.

FIG. 2 schematically illustrates the electric machine 4 of the vehicle 20 illustrated in FIG. 1. The electric machine 4 comprises a rotor 8 and a stator 5. As is further explained herein, the stator 5 is configured to induce a torque to the rotor 8 to rotate the rotor 8 around a rotation axis Ax.

The electric machine 4 further comprises a stator housing 7 enclosing at least part of the stator 5 and the rotor 8 of the electric machine 4. The stator housing 7 comprises a coolant inlet 11 and a coolant outlet 12. As is further explained herein, the vehicle 20 comprises a cooling system configured to pump a coolant, such as oil or a water/glycol mixture, through a coolant volume of the electric machine 4 via the coolant inlet 11 and the coolant outlet 12.

The electric machine 4 further comprises an output shaft 33. The output shaft 33 is connected to the rotor 8 of the electric machine 4. The output shaft 33 of the electric machine 4 may be operably connected to one or more wheels 57 of a vehicle 20 comprising the electric machine 4, for example via a number of transmission units, such as one or more gearboxes, shafts, gear pairs, differentials, and the like.

According to some embodiments, the electric machine 4 may be a wheel hub motor. According to such embodiments, the output shaft 33 of the electric machine 4 may be directly connected to a wheel of a vehicle comprising the electric machine 4, or may be connected to the wheel via a transmission unit, such as a planetary gearbox, or the like.

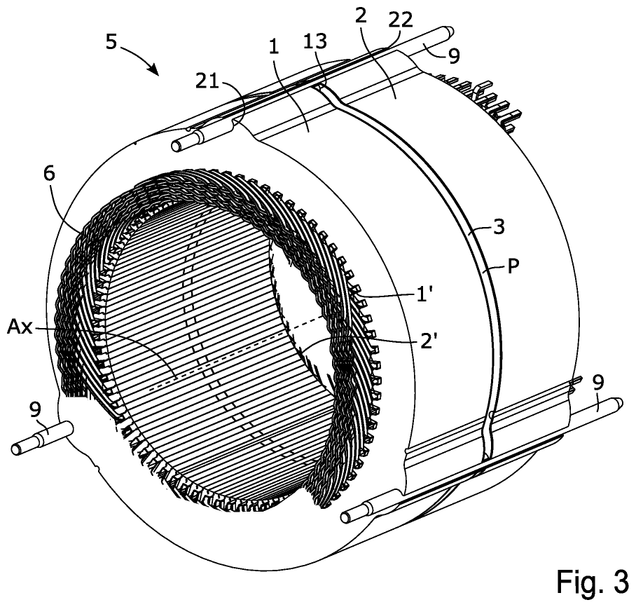

FIG. 3 illustrates a perspective view of a stator 5 of the electric machine 4 illustrated in FIG. 2. The stator 5 comprises a first stator core portion 1 and a second stator core portion 2. According to the illustrated embodiments the first and second stator core portions 1, 2 form distinct separate parts. Moreover, the stator 5 comprises a cooling unit 3 positioned between the first and second stator core portions 1, 2 as seen along the rotation axis Ax. Thus, according to the illustrated embodiments, the first and second stator core portions 1, 2 are separated from each other by the cooling unit 3.

Each of the first and second stator core portions 1, 2 may be formed by an electro plate laminate comprising a plurality of thin plates stacked and attached to each other. The stacked laminations may be made of electrically insulated material, such as silicon steel or electrical-grade iron. The laminations are typically coated or varnished to minimize eddy current losses, which can occur due to magnetic field variations.

Moreover, each of the first and second stator core portions 1, 2 comprises a number of stator slots 1′, 2′. The stator 5 comprises a number of wire windings 6 arranged in the stator slots 1′, 2′ of the first and second stator core portions 1, 2. The stator slots 1′, 2′ are formed between teeth that extend inward towards the rotor or the electric machine 4.

Below, simultaneous reference is made to FIG. 1-FIG. 3, if not indicated otherwise. According to the illustrated embodiments, the rotor 8 comprises a set of permanent magnets and the wire windings 6 are continuous wire windings. In more detail, according to the illustrated embodiments, the wire windings 6 are form wound wires. Form wound wires is a type of pre-shaped continuous wire winding which may require no welding during an assembling procedure of the stator 5. The wire windings 6, as referred to herein, may also be referred to as coil wire windings 6. In FIG. 3, some portions of the wire windings 6 have been omitted for reasons of brevity and clarity. However, according to the illustrated embodiments, the wire windings 6 are symmetrically arranged in the stator slots 1′, 2′ of the first and second stator core portions 1, 2.

In embodiments where the electric machine 4 operates as an electric motor, an electric current fed through the wire windings 6 generates a magnetic field inducing a torque causing rotation of the rotor 8 around the rotation axis Ax. In embodiments where the electric machine 4 operates as an electric generator, an electric current is generated in the wire windings 6 from a magnetic field of the permanent magnets of the rotor 8 upon rotation of the rotor 8 around the rotation axis Ax. Thus, in such embodiments, and in such situations, the stator 5 induces a torque to the rotor 8 braking the rotation of the rotor 8 around the rotation axis Ax.

The stator 5 is thus configured to induce, i.e. apply, a torque to a rotor 8 of an electric machine 4 by the interaction between a magnetic field of the stator 5 and a magnetic field of the rotor 8. The induced torque may be a torque causing rotation of the rotor 8 or a torque braking rotation of the rotor 8, as explained above.

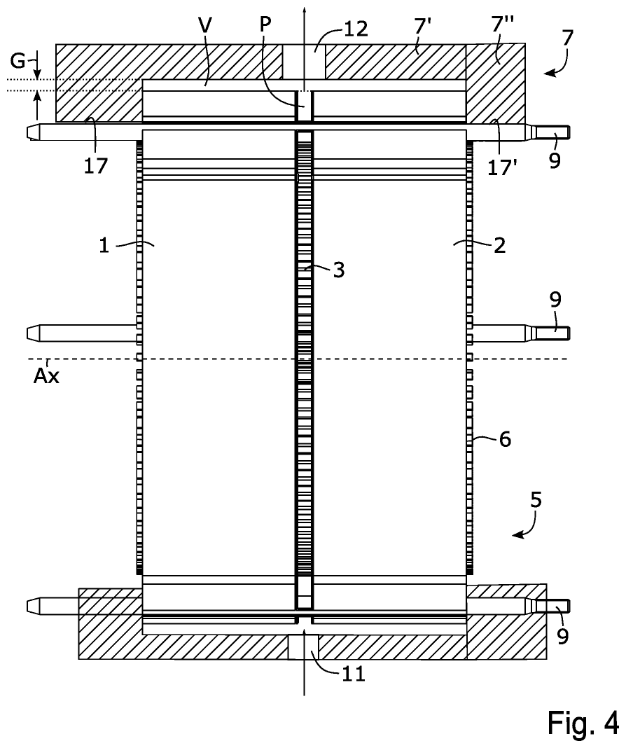

FIG. 4 illustrates a sectional view of a stator housing 7 and a stator 5 of an electric machine 4 according to the embodiments illustrated in FIG. 2 and FIG. 3. In FIG. 4, the stator housing 7 and the stator 5 are oriented such that the rotation axis Ax of the rotor is perpendicular to a viewing direction of FIG. 4. Also in FIG. 4, some portions of the wire windings 6 have been omitted for reasons of brevity and clarity.

As is seen in FIG. 4, according to the illustrated embodiments, the first and second stator core portions 1, 2 have the same length measured in a direction coinciding with the rotation axis Ax of the rotor. According to further embodiments, the first and second stator core portions 1, 2 may have substantially the same length measured in a direction coinciding with the rotation axis Ax of the rotor. The feature that the first and second stator core portions 1, 2 have substantially the same length measured in a direction coinciding with the rotation axis Ax of the rotor may encompass that the lengths of the first and second stator core portions 1, 2 differ less than 15% from each other.

As mentioned, the cooling unit 3 is arranged between the first stator core portion 1 and the second stator core portion 2 and structurally separates the first and second stator core portions 1, 2. That is, according to the illustrated embodiments, the cooling unit 3 is a plate-like separate unit that is clamped between the first and second stator core portions 1, 2. The cooling unit 3, as referred to herein, may also be referred to as a cooling plate, a cooling member, or the like.

As seen in FIG. 3 and FIG. 4, according to the illustrated embodiments, the stator 5 comprises a set of mounting rods 9. According to the illustrated embodiments, the stator 5 comprises three mounting rods 9. According to further embodiments, the stator may comprise another number of mounting rods 9, such as two, four, or five mounting rods 9.

Each mounting rod 9 has a greater length than a total length formed by the first stator core portion 1, the cooling unit 3, and the second stator core portion 2. As is indicated in FIG. 3, each of the first and second stator core portions 1, 2 comprises mounting portions 21, 22 each accommodating a mounting rod 9. Moreover, as in indicated in FIG. 3, the cooling unit 3 comprises mounting portions 13 each accommodating a mounting rod 9.

As is indicated in FIG. 4, according to the illustrated embodiments, the stator housing 7 comprises a first housing portion 7′ and a second housing portion 7″. Each of the first and second housing portion 7′, 7″ comprises a number of mounting portions 17, 17′ accommodating a mounting rod 9. According to the illustrated embodiments, each of the mounting portions 17, 17′ of the first and second housing portions 7′, 7″ comprises a through hole receiving a mounting rod 9.

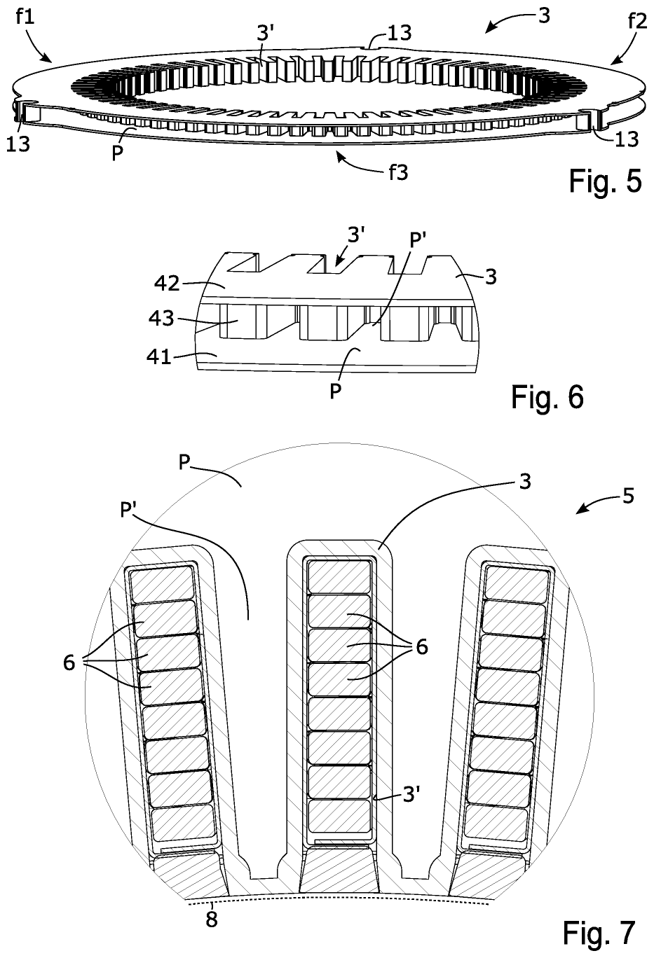

FIG. 5 illustrates a perspective view of a cooling unit 3 of an electric machine 4 explained with reference to FIG. 1-FIG. 4. As is seen in FIG. 5, the cooling unit 3 comprises a number of stator slots 3′. When a stator 5 comprising the cooling unit 3 is an assembled state, as is illustrated in FIG. 3 and FIG. 4, the number of wire windings 6 is arranged in the stator slots 3′ of the cooling unit 3. Moreover, as seen in FIG. 5, according to the illustrated embodiments, the cooling unit 3 comprises a number of mounting portions 13.

The following is explained with simultaneous reference to FIG. 1-FIG. 5. In an assembly procedure of the stator 5 according to the illustrated embodiments, an assembler, or an assembling machine, may position the cooling unit 3 between the first and second stator core portions 1, 2 and orient the first and second stator core portions 1, 2 and the cooling unit 3 such that the mounting portion 21, 13, 22 of the respective component are aligned relative to each other in directions parallel to the rotation axis Ax. According to the illustrated embodiments, the first and second stator core portions 1, 2 and the cooling unit 3 are designed such that the stator slots 1′, 2′, 3′ of the respective component becomes aligned in corresponding directions when the mounting portions 21, 13, 22 are aligned.

Then, the assembler, or the assembling machine, may insert the mounting rods 9 through the mounting portion 17, 17′ of one of the first and second housing portions 7′, 7″ of the stator housing 7, and into the mounting portions 21, 13, 22 of the first and second stator core portions 1, 2 and the cooling unit 3, and then through the mounting portion 17, 17′ of the other of the first and second housing portions 7′, 7″.

Then, the assembler, or the assembling machine, may thus then insert the wire windings 6 in the stator slots 1′, 2′, 3′ of the first and second stator core portions 1, 2 and the cooling unit 3. According to the illustrated embodiments, each mounting rod 9 is provided with two threaded ends configured to receive a nut threaded thereon. According to further embodiments, only one of the two ends may be threaded, wherein the opposite end may comprise an enlarged portion to provide an abutment against a portion of the stator housing 7.

The assembler, or the assembling machine, may thread nuts onto the threaded portions of the mounting rods 9 and may tighten the nuts. As a result, the first and second housing portions 7′, 7″ are clamped toward each other, i.e., are clamped toward each other in directions parallel to the rotation axis Ax.

Moreover, because the first and second stator core portions 1, 2 are positioned between the first and second housing portions 7′, 7″ and the cooling unit 3 is positioned between the first and second stator core portions 1, 2, the first and second stator core portions 1, 2 becomes clamped toward each other in directions parallel to the rotation axis Ax with the cooling unit 3 positioned therebetween. In other words, the cooling unit 3 becomes clamped between the first and second stator core portions 1, 2 when tighten the nuts in the above-described assembly procedure of the stator 5.

According to further embodiments, the above described assembling steps may be performed in a different order than described above.

As indicated in FIG. 3-FIG. 5, the cooling unit 3 forms a coolant path P. That is, in more detail, as indicated in FIG. 4, the stator 5 comprises a radial gap G between the stator housing 7 and each of the first and second stator core portions 1, 2 and the cooling unit 3. The radial gap G forms a coolant volume V enclosing at least part of each of the first and second stator core portions 1, 2 and the cooling unit 3. According to the illustrated embodiments, the coolant volume V encloses the rotation axis Ax.

In FIG. 4, the coolant inlet 11 and the coolant outlet 12 of the stator housing 7 is indicated. Each of the coolant inlet 11 and the coolant outlet 12 is fluidly connected to the coolant volume V. Moreover, according to the illustrated embodiments, the coolant path P is fluidly connected to the coolant inlet 11 and the coolant outlet 12 respectively via the coolant volume V.

That is, as is indicated in FIG. 5, the cooling unit 3 comprises a number of open faces f1, f2, f3. Each of the number of open faces f1, f2, f3 faces the coolant volume V. A coolant pumped into the coolant inlet 11 of the stator housing 5 is thus free to flow between the coolant volume V and the coolant path P formed by the cooling unit 3 and then to the coolant outlet 12 of the stator housing 5.

As can be seen when comparing FIG. 3-FIG. 5, according to the illustrated embodiments, the coolant path P encloses the entire rotation axis Ax. In other words, the cooling unit 3 forms a coolant path P enclosing the entire rotation axis Ax. According to further embodiments, the cooling unit 3 may form a coolant path P extending along more than 40% of a circumference of the stator 5.

According to the illustrated embodiments, the number of open faces f1, f2, f3 of the cooling unit 3 faces the coolant volume V along more than 90% of the circumference of the cooling unit 3. According to further embodiments, the number of open faces f1, f2, f3 may together face the coolant volume V along more than 40% of the circumference of the cooling unit 3.

As understood from the above, each of the number of open faces f1, f2, f3 is open in a radial direction towards the coolant volume V. Moreover, each of the number of open faces f1, f2, f3 forms a boundary between the coolant path P and the coolant volume V, wherein the boundary is imaginary, and wherein fluid is free to flow between the coolant path P and the coolant volume V via each of the number of open faces f1, f2, f3. Each of the number of open faces f1, f2, f3 may also be referred to as an open section, a radially open section, or the like.

FIG. 6 illustrates an enlarged portion of the cooling unit 3 illustrated in FIG. 5. As is indicated in FIG. 6, the coolant path P comprises a number of sections P′ located between stator slots 3′ of the cooling unit 3. The features, functions, and advantages of the number of sections P′ is further explained with reference to FIG. 7 below.

Moreover, as indicated in FIG. 6, the cooling unit 3 comprises a first side wall 41, a second side wall 42, and an inner wall 43 connecting the first and second side walls 41, 42. When the stator 5 is in an assembled state, as is illustrated in FIG. 3 and FIG. 4, the first side wall 41 is in abutting contact with the first stator core portion 1 and the second side wall 42 is in abutting contact with the second stator core portion 2. According to the illustrated embodiments, each of the first and second side walls 41, 42 is planar in a plane perpendicular to the rotation axis Ax.

As seen in FIG. 5 and FIG. 6, the first and second side walls 41, 42 and the inner wall 43 together forms the stator slots 3′ of the cooling unit 3. According to the illustrated embodiments, the coolant path P is delimited by a respective inner surface of the first and second side walls 41, 42 and an inner surface of the inner wall 43 of the cooling unit 3. The cooling unit 3 can be said to form the coolant path P by forming an axial spacing between the first and second stator core portions 1, 2. According to some embodiments, the cooling unit 3 may lack one or both of the first and second side walls 41, 42. According to such embodiments, a side surface of one or both of the first and second stator core portions 1, 2 may delimit the coolant path P together with the inner surface of the inner wall 43.

FIG. 7 illustrates a cross section of a portion of a stator 5 explained with reference to FIG. 1 FIG. 6. Moreover, in FIG. 7, a rotor 8 is schematically indicated. In FIG. 7, the cross section is made in a plane perpendicular to a rotation axis of the rotor 8 at a location of the cooling unit 3 of the stator 5.

Below, simultaneous reference is made to FIG. 1-FIG. 7, if not indicated otherwise. In FIG. 7, the wire windings 6 of the stator 5 can be seen. The wire windings 6 are arranged in the stator slots 3′ of the cooling unit 3. Moreover, as mentioned, the number of sections P′ of the coolant path P is located between stator slots 3′ of the cooling unit 3 and thereby also between the wire windings 6 of the stator 5. In this manner, it can be ensured that coolant flowing through the coolant path P can reach locations close to hot portions of the electric machine 4 between the wire windings 6 to thereby cool the hot portions of the stator 5 in a more efficient manner.

Moreover, as mentioned, according to the illustrated embodiments, the cooling unit 3 is arranged between the first and second stator core portions 1, 2 and the first and second stator core portions 1, 2 have the same length as measured in directions parallel to the rotation axis Ax of the rotor 8. In other words, according to the illustrated embodiments, the cooling unit 3 is arranged at an axial centre of the stator 5.

A radially inner portion of a stator at an axial centre thereof normally constitutes a hot portion of the stator. A continuous power and torque output of an electric machine must normally be limited in order not to exceed a threshold temperature of this portion of a stator of the electric machine. However, as seen in FIG. 3-FIG. 7, due to the features of the stator 5 according to embodiments herein, the radially inner portions of the stator 5 at the axial centre of the stator 5 is cooled in an efficient manner which allows for higher continuous power and torque output of the electric machine 4 without overheating this portion of the stator 5.

Moreover, as seen in FIG. 3 and FIG. 4, according to the illustrated embodiments, the cooling unit 3 has a considerable smaller length than each of the first and second stator core portions 1, 2 as measured in a direction coinciding with the rotation axis Ax. According to some embodiments, the length of the cooling unit 3 is less than 10% of the length of each of the first and second stator core portions 1, 2 as measured in a direction coinciding with the rotation axis Ax. In this manner, it can be ensured that hot portions of the stator 5 can be cooled in an efficient manner while not significantly affecting the operational performance of an electric machine 4 comprising the stator 5.

According to further embodiments, the stator 5 may comprise another number of cooling units 3 than one, and consequently also another number of stator core portions 1, 2 than two. For example, the stator 5 may comprise two cooling units 3 and three stator core portions 1, 2. In such embodiments, the two cooling units may be separated by one of the three stator core portions. Moreover, according to such embodiments, the three stator core portions may have the same length as measured in a direction parallel to a rotation axis of a rotor. As an alternative, the stator core portion positioned between the two cooling units may have a smaller length than the other two stator core portions as measured in a direction parallel to the rotation axis. In this manner, it can be ensured that radially inner portions of an axial centre of the stator can be cooled in an efficient manner.

As can be seen in FIG. 2 and FIG. 4, according to the illustrated embodiments, the coolant inlet 11 and the coolant outlet 12 are arranged on opposite sides of the rotation axis Ax.

Moreover, in FIG. 2 and FIG. 4, a vertical direction vd is indicated. In FIG. 2 and FIG. 4, the stator 5 and the stator housing 7 are illustrated in an intended mounting orientation relative to the vertical direction vd. As can be seen in FIG. 2 and FIG. 4, the coolant outlet 12 is located above the coolant inlet 11 as seen relative to the vertical direction vd of the vehicle 20 when the stator housing 7 is oriented in the intended mounting orientation relative to the vertical direction vd. In this manner, it can be ensured that air bubbles entering the coolant volume V and the coolant path P can be transported by gravity to the coolant outlet 12 of the stator housing 7.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

As used herein, the term “comprising” or “comprises” is open-ended, and includes one or more stated features, elements, steps, components, or functions but does not preclude the presence or addition of one or more other features, elements, steps, components, functions, or groups thereof.

1. A stator for an electric propulsion machine wherein the stator is configured to induce a torque to a rotor of the electric propulsion machine to rotate the rotor around a rotation axis, wherein the stator comprises:
a first stator core portion,
a second stator core portion and
a cooling unit positioned between the first and second stator core portions as seen along the rotation axis wherein the cooling unit forms a coolant path extending along more than 40% of a circumference of the stator.

2. The stator according to claim 1, wherein the coolant path encloses the rotation axis.

3. The stator according to claim 1, wherein the cooling unit is clamped between the first and second stator core portions.

4. The stator according to claim 1, wherein each of the first and second stator core portions and the cooling unit comprises a number of stator slots, and wherein the stator comprises a number of wire windings arranged in the stator slots, and wherein the coolant path comprises a number of sections located between stator slots of the cooling unit.

5. The stator according to claim 1, wherein the stator comprises a stator housing accommodating at least part of the first and second stator core portions, and wherein the stator housing comprises a coolant inlet and a coolant outlet each fluidly connected to the coolant path

6. The stator according to claim 5, wherein the coolant inlet and the coolant outlet are arranged on opposite sides of the rotation axis.

7. The stator according to claim 5, wherein the stator comprises a radial gap between the stator housing and each of the first and second stator core portions wherein the radial gap forms a coolant volume enclosing at least part of each of the first and second stator core portions, and wherein the coolant path is fluidly connected to the coolant inlet and the coolant outlet respectively via the coolant volume.

8. The stator according to claim 7, wherein the cooling unit comprises a number of open faces together facing the coolant volume along more than 40% of the circumference of the cooling unit.

9. An electric propulsion machine comprising a rotor and a stator according to claim 1, wherein the stator is configured to induce a torque to the rotor to rotate the rotor around a rotation axis

10. A vehicle comprising an electric propulsion machine according to claim 9, wherein the electric propulsion machine is configured to provide motive power to the vehicle.

11. The vehicle according to claim 10, wherein the vehicle is a heavy road vehicle, such as a truck or a bus.
